(19) United States
(12) Patent Application Publication
(10) Pub. No.: US 2023/0128284 A1
(43) Pub. Date: Apr. 27, 2023

(54) METHODS AND SYSTEMS FOR ESTIMATING THE CURRENT WEIGHT OF COMMERCIAL VEHICLES

(71) Applicant: Harbinger Motors Inc., Gardena, CA (US)

(72) Inventors: Phillip John Weicker, Los Angeles, CA (US); William Clarke Eberts, Los Angeles, CA (US); John Henry Harris, III, Anaheim, CA (US)

(73) Assignee: Harbinger Motors Inc., Gardena, CA (US)

(21) Appl. No.: 17/655,199

(22) Filed: Mar. 17, 2022

Related U.S. Application Data
(60) Provisional application No. 63/271,005, filed on Oct. 22, 2021.

(51) Int. Cl. G07C 5/00; B60W 40/13; B60W 40/105

(52) U.S. Cl. CPC G07C 5/006; B60W 40/13; B60W 40/105; B60W 2510/22; B60W 2300/14

(57) ABSTRACT

Described herein are methods and systems for estimating the current weight of commercial vehicles. A system comprising a weight estimator, which receives input from one or more vehicle systems and/or sensors, such as suspension, power train, speedometer, tire pressure monitoring system, and the like. The weight estimator uses these inputs to determine one or more weight values associated with the vehicle, such as the total vehicle weight, weight distribution per axle, weight distribution per wheel, load distribution, and the like. In some examples, the weight estimator submits these weight values to one or more other systems. For example, the weight values may be used as an indicator that the vehicle is overloaded and/or that the weight is distributed unevenly. In some examples, the weight values are used by a maintenance scheduler to determine the next required maintenance.

### CROSS-REFERENCE TO RELATED APPLICATIONS

This application claims the benefit under 35 U.S.C. § 119(e) of US Provisional Patent Application No. 63/271,005, filed on 2021 Oct. 22, which is incorporated herein by reference in its entirety for all purposes.

### BACKGROUND

Commercial vehicles can experience major weight changes, e.g., between an empty vehicle and a fully-loaded vehicle. For example, in the US, a semi-truck (without a trailer) can weigh about 25,000 pounds, while a semi-truck with a loaded trailer can weigh up to 80,000 pounds. The weight has a significant impact on the vehicle operation, e.g., driving dynamics, vehicle stability, braking, fuel consumption, and the like. One will readily understand that a fully-loaded vehicle takes longer to accelerate and brake. At the same time, conventional commercial vehicles are typically tuned for one specific target weight without any specific provisions for weight changes. Operating a vehicle outside of this target weight is common but suboptimal and requires special skills and training from the driver. As such, operating many commercial vehicles, especially large and heavy commercial vehicles, requires special licenses. On the other hand, there is a huge demand for commercial drivers, especially for drivers performing last-mile deliveries.

What is needed are new methods and systems for estimating the current weight of commercial vehicles and utilizing this information to assist drivers and improve the driving experience.

### SUMMARY

Described herein are methods and systems for estimating the current weight of commercial vehicles. A system comprising a weight estimator, which receives input from one or more vehicle systems and/or sensors, such as suspension, powertrain, speedometer, tire pressure monitoring system, and the like. The weight estimator uses these inputs to determine one or more weight values associated with the vehicle, such as the total vehicle weight, weight distribution per axle, weight distribution per wheel, load distribution, and the like. In some examples, the weight estimator submits these weight values to one or more other systems. For example, the weight values may be used to trigger an indicator that the vehicle is overloaded and/or that the weight is distributed unevenly. In some examples, the weight values are used by a maintenance scheduler to determine the next required maintenance.

In some examples, a method of estimating the weight of a commercial vehicle comprising receiving, at a weight estimator, one or more inputs from a first set of systems of the commercial vehicle. The one or more inputs comprise at least one of one or more load cell outputs, one or more wheel travel values, one or more bump stop outputs, a speed value, power train data, a trailer presence, and one or more tire pressure values. The method also comprises determining one or more weight values corresponding to the commercial vehicle based on the one or more inputs. The method comprises transmitting the one or more weight values to a second set of systems of the commercial vehicle.

In some examples, the first set of systems of the commercial vehicle comprises one or more load cells, one or more wheel travel sensors, one or more bump-stop sensors, a speedometer, a power train, a tire pressure monitoring system, and a trailer presence sensor. In the same or other examples, the second set of systems of the commercial vehicle comprises a load analyzer. In other examples, the second set of systems of the commercial vehicle comprises a maintenance scheduler.

In some examples, the one or more inputs comprise the one or more load cell outputs, received from one or more load cells. In the same or other examples, the one or more inputs comprise the one or more wheel travel values. In these examples, determining the one or more weight values comprises analyzing the one or more wheel travel values based on vehicle suspension settings.

In some examples, the one or more inputs comprise the one or more bump stop outputs. In these examples, determining the one or more weight values comprises analyzing the one or more bump stop outputs based on vehicle suspension settings. Furthermore, the one or more inputs may comprise acceleration values, received from an inertial measurement unit. In these examples determining the one or more weight values is further performed based on the acceleration values.

In some examples, the one or more inputs comprise a speed value, received at different times. Determining the one or more weight values comprises determining vehicle acceleration from changes in the speed value. In more specific examples, determining the one or more weight values further comprises comparing the vehicle acceleration to the power train data.

In some examples, the one or more weight values comprise at-wheel weight values, each corresponding to each individual wheel of the commercial vehicle. For example, the at-wheel weight values are determined from the tire pressure values. The tire pressure values are obtained for each individual wheel of the commercial vehicle. In some examples, the one or more inputs comprise ambient temperature. The at-wheel weight values are determined are further determined based on the ambient temperature.

In some examples, the one or more weight values comprise the trailer presence received from a trailer hook-up system. The trailer hook-up system generates the trailer presence based on one or more of trailer lights and trailer brakes.

In some examples, the one or more inputs comprise a user input received from a user interface. The user interface comprises one or more of a touch-screen in a vehicle cabin or a driver's mobile device, communicatively coupled to the weight estimator. For example, the user input is selected from the group of an externally obtained vehicle weight and a trailer presence.

In some examples, the one or more weight values are selected from the group consisting of a total weight of the commercial vehicle, a weight per axle of the commercial vehicle, a weight per wheel of the commercial vehicle, and weight at a specific location in the commercial vehicle.

In some examples, determining the one or more weight values is performed using one or more lookup tables stored in a memory of the weight estimator.

In some examples, the one or more inputs comprise multiple input received from multiple different systems in the first set of systems of the commercial vehicle.

Also provided is a weight estimator for estimating the weight of a commercial vehicle. In some examples, the weight estimator comprises instructions for receiving one or more inputs from a first set of systems of the commercial vehicle. The one or more inputs comprise at least one of one or more load cell outputs, one or more wheel travel values, one or more bump stop outputs, a speed value, power train data, a trailer presence, and one or more tire pressure values. Further instructions at the weight estimators may include determining one or more weight values corresponding to the commercial vehicle based on the one or more inputs and transmitting the one or more weight values to a second set of systems of the commercial vehicle.

These and other embodiments are described further below with reference to the figures.

### BRIEF DESCRIPTION OF THE DRAWINGS

FIGS. 1A, 1B, and 1C are schematic illustrations of weight profiles corresponding to different commercial vehicles and operating examples.

FIG. 2A is a schematic illustration of a commercial vehicle, comprising a weight estimator, in accordance with some examples.

FIG. 2B is a schematic illustration of a commercial vehicle receiving an external weight estimation, in accordance with some examples.

FIG. 3 is a process flowchart corresponding to a method of estimating the weight of a commercial vehicle, in accordance with some examples.

FIG. 4 is a schematic illustration of deriving additional weight values for a commercial vehicle, in accordance with some examples.

FIG. 5 is a block diagram of a computer system, operable as a weight estimator in a commercial vehicle, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

Introduction

As noted above, commercial vehicles can experience major weight changes during their operation. For example, trucks can be unloaded, partially loaded, or fully loaded. A trailer may be hooked to a truck to transport additional loads. The weight change may be sudden (e.g., loading 35,000 pounds in a trailer of a semi-truck) or incremental (e.g., delivering packages or collecting garbage). Furthermore, some weight changes can be not easily predictable (e.g., passengers leaving or entering a bus at the next bus stop).

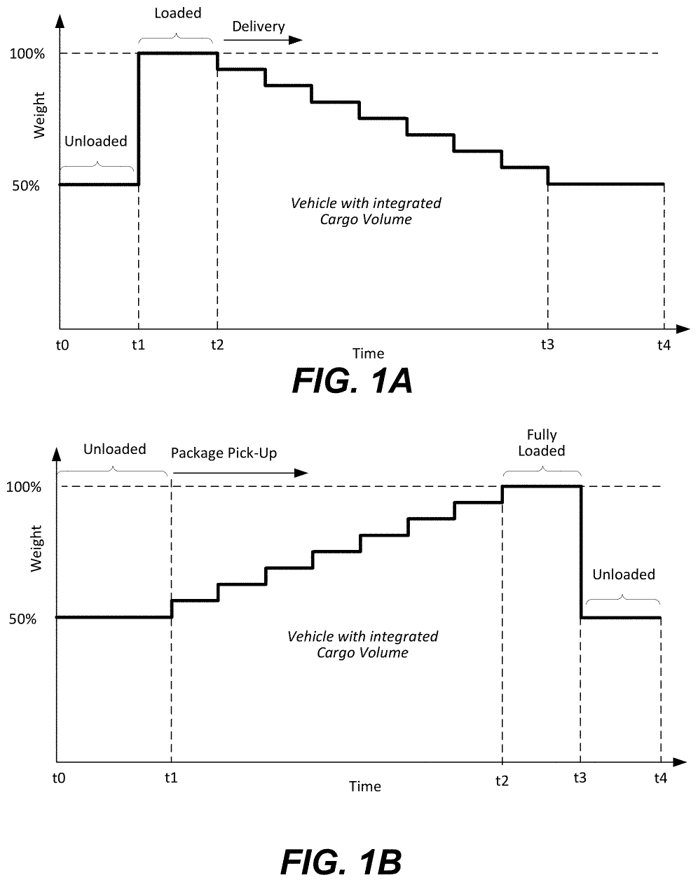

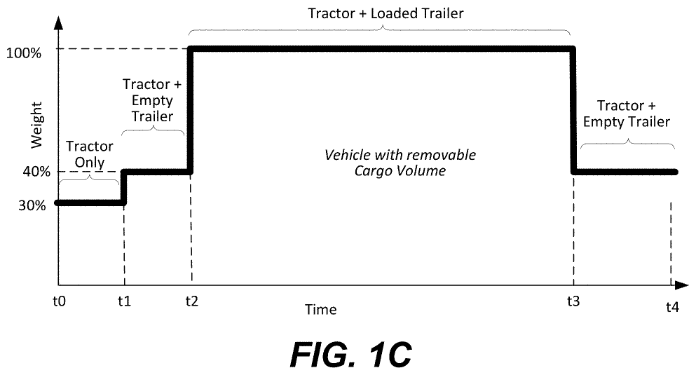

FIGS. 1A and 1B are schematic illustrations of weight profile examples of two types of commercial vehicles performing different operations. FIGS. 1A and 1B represent a vehicle with an integrated cargo volume, e.g., a delivery van, a box truck. For example, the curb weight of a typical delivery van (e.g., Mercedes-Benz Sprinter) is about 5,000-7,000 lbs. The payload capacity is also about 5,000-7,000 lbs. In other words, the curb weight represents about 50% of the loaded weight. Referring to FIG. 1A, an unloaded vehicle is driven from t0 to t1, at which point, the vehicle is loaded. In this example, the load and the vehicle each represent about 50% of the total weight (100%). From t1 to t2, the fully-loaded vehicle is driven (e.g., to its first delivery) which continues until t3. At t3, the vehicle is completely unloaded and is driven back (e.g., back to the loading location). Referring to FIG. 1B, an unloaded vehicle is driven from t0 to t1, which corresponds to a first pick-up location. Additional package pick-ups continue until t2, at which point the fully-loaded vehicle is driven (between t2 and t3) to a drop-off location. At t3, the vehicle is completely unloaded and is driven back (e.g., to a new package pickup location).

FIG. 1C represents a vehicle with a removable cargo volume, e.g., a semi-truck. For example, the curb weight of a typical semi-truck without a trailer is about 25,000 lbs. A semi-truck with an empty trailer weighs about 35,000 lbs, while a semi-truck with a fully loaded trailer can weigh as much as 80,000 lbs. In other words, the weight of a semi-truck without a trailer represents about 30% of the total loaded weight, while the weight of a semi-truck with an empty trailer represents about 40% of the total loaded weight. Referring to FIG. 1B, a semi-truck without a trailer is driven from t0 to t1, at which point, an empty trailer is hooked up to the truck. From t1 to t2, the semi-truck with the empty trailer is driven to its loading destination. From t2 to t3, the loaded semi-truck is driven to a load dropoff location, at which point the trailer is unloaded and the semi-truck with the empty trailer is driven away.

One having ordinary skill in the art would appreciate that vehicle weight has a significant impact on the vehicle operation. For example, a heavier vehicle needs more power to accelerate and harder braking (and possibly longer distance) to slow down. Additional weight and also weight distribution impacts vehicle stability. For example, a loaded semi-truck tends to have a much higher center of gravity than the unloaded one. This impact can be further applied by road conditions (e.g., grade, traction) and other factors.

At the same time, different vehicle systems (e.g., braking, power management, suspension) are tuned for specific weight targets in conventional commercial vehicles. In other words, the same setup is used regardless of the current vehicle weight, e.g., for fully loaded vehicles and also for unloaded vehicles. The responsibility for weight variations falls on drivers.

Specifically, a driver has to be aware of the current vehicle weight (e.g., at least intuitively) and adjust drivers' control input to accommodate for the vehicle dynamics caused by different weights. Fully relying on the driver to compensate for vehicle weight variations puts a lot of stress on the driver and requires a large amount of skill. As a result, commercial vehicles require special operating licenses, especially large vehicles such as semi-trucks.

Described herein are methods and systems for in situ estimating the weight of commercial vehicles and using these weight estimates for various controls, e.g., adjusting vehicle systems, providing inputs, and the like. For example, the weight can be estimated automatically by the vehicle and during normal vehicle operation. The vehicle does not need to travel to special locations (e.g., truck weight scales) or use any specific external devices. The weight estimate is performed by the vehicle systems, in particular by a weight estimator that receives various inputs from other vehicle systems.

### Weight Estimator Examples

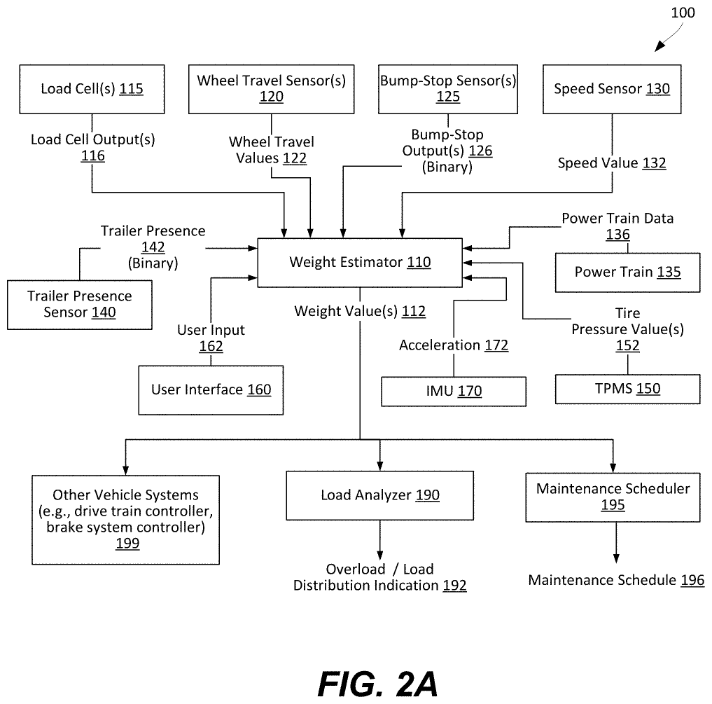

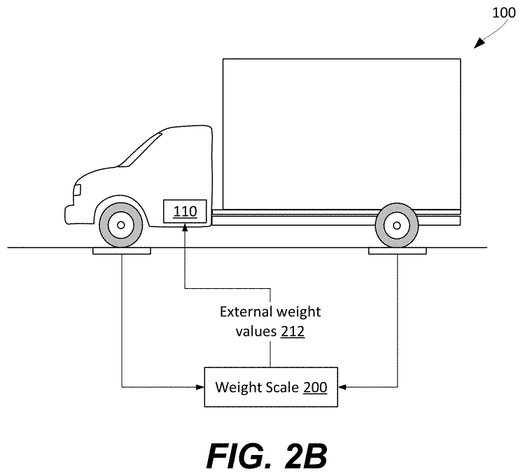

FIG. 2A is a schematic illustration of commercial vehicle 100, comprising weight estimator 110, in accordance with some examples. Weight estimator 110 is configured to receive input from one or more vehicle systems or, more specifically, existing vehicle systems. Weight estimator 110 uses these inputs to estimate the weight of the vehicle. In other words, the process is performed at the vehicle integration level using vehicle sensors and without a need for additional systems, either on the vehicle or external to the vehicle. Weight estimator 110 can be a standalone hardware component (e.g., an electronic unit/computer system) or integrated into another system on vehicle 100 (e.g., one of the vehicle control modules).

For example, weight estimator 110 is configured to receive input from one or more load cells 115 of vehicle 100. This type of weight estimator's input may be also referred to as load cell output 116. These load cells 115 are positioned, e.g., at each axle or even at each wheel of vehicle 100.

In the same or other examples, weight estimator 110 is configured to receive input from one or more wheel travel sensors 120. This type of weight estimator's input may be also referred to as wheel travel values 122. More specifically, each wheel travel sensor 120 is configured to measure the movement (deflection) of the corresponding wheel relative to the vehicle body (e.g., frame). This input may be coupled with the current suspension settings, e.g., to determine the weight estimate. In some examples, weight estimator 110 comprises various calibration data to interpret this and other types of input to determine weight values 112.

In some examples, weight estimator 110 is configured to receive input from one or more bump-stop sensors 125. This type of weight estimator's input may be also referred to as bump-stop outputs 126 and can be in a binary form (e.g., “Contact” and “No Contact”). Bump-stop sensor 125 is configured to detect when the suspension (e.g., a shock absorber) reaches its limit defined by this sensor. In some examples, this input may be combined acceleration input 172 from inertial measurement unit (IMU) 170. For example, IMU 170 can measure accelerations along one or more axes, such as measuring the vertical acceleration immediately prior to reaching the bump-stop limit) and/or with the current suspension settings, e.g., to determine the weight estimate.

In some examples, weight estimator 110 is configured to receive input from speedometer 130. More specifically, speedometer 130 repeatedly provides current speed value 132. Weight estimator 110 uses multiple instances of speed value 132 as well as the duration between these instances to determine vehicle acceleration. Weight estimator 110 then combines the vehicle acceleration with the vehicle power input (e.g., power train data 136 received from power train 135) to determine the vehicle weight (e.g., m=F/a).

In some examples, weight estimator 110 is configured to receive tire pressure values 152 from tire pressure monitoring system (TPMS) 150. Specifically, tire pressure values 152, correspond to the weight, supported by the tires. In general, a higher supported weight corresponds to a higher pressure. For example, weight estimator 110 may comprise lookup tables with correlations of tire pressure values and vehicle weights. In more specific examples, weight estimator 110 may also use ambient temperature as an input, as the ambient temperature also influences the tire pressure.

In some examples, weight estimator 110 is configured to receive trailer presence input 142 from trailer hookup system 142. Trailer presence input 142 is another example of a binary input, e.g., “trailer hooked up” and “no trailer.” For example, trailer hookup system 142 may monitor trailer lights, trailer brakes, or other systems associated with the trailer.

In some examples, weight estimator 110 is configured to receive user input 162 from user interface 162. For example, user interface 162 can be a touch-screen in the vehicle cabin or the driver's mobile device (e.g., a smartphone), which is communicatively coupled to weight estimator 110 (e.g., wirelessly or with wired connections). Some examples of user input 162 include, but are not limited to, externally obtained vehicle weight (e.g., presented to the driver), trailer presence, and the like.

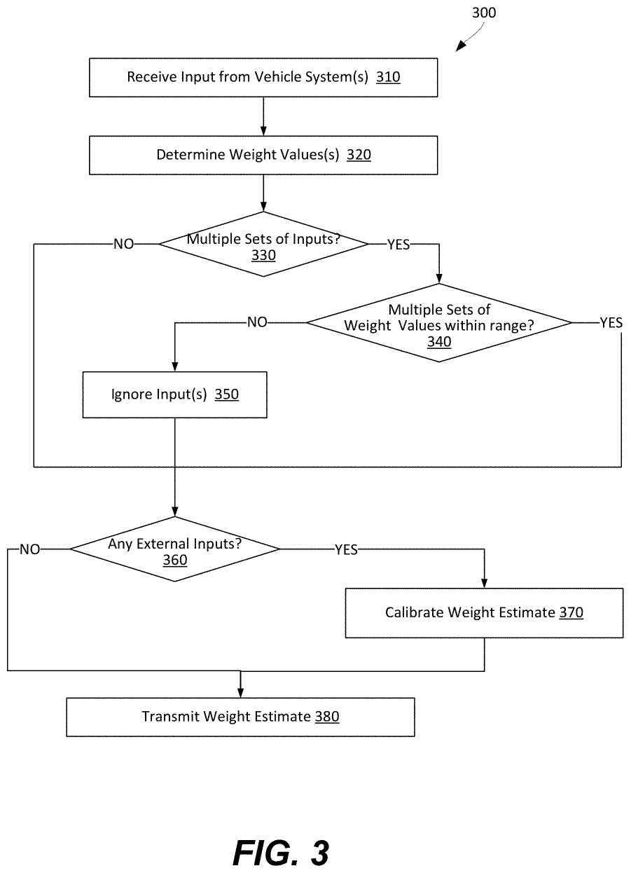

Weight estimator 110 uses one or more of these inputs to determine one or more weight values as described below with reference to FIG. 3. Different types of weight values 112 are within the scope, e.g., a total weight, a weight per axle, a weight per wheel, a weight at a specific location in the vehicle (e.g., in the loading area). Weight estimator 110 may transmit these weight values to other vehicle systems, such as load analyzer 190, maintenance scheduler 195, and/or other vehicle systems 199, such as a drivetrain controller and/or brake system controller. These other systems can use weight values 112 to further improve the operation of vehicle 110, e.g., to change vehicle dynamics (acceleration and/or braking) and/or change loading configuration.

FIG. 2B is a schematic illustration of vehicle 100 positioned on weight scale 200, which is external to vehicle 100. In some examples, weight scale 200 is configured to generate one or more external weight values 212, e.g., the total vehicle weight, the weight per axle, the weight per wheel. Furthermore, weight scale 200 is configured to transmit these external weight values 212 to vehicle 100 or, more specifically, to weight estimator 110. Weight estimator 110 can use these external weight values 212 as references while analyzing internal inputs, e.g., from vehicle sensors. For example, weight estimator 110 can establish correlations between these internal inputs and external weight values 212 and later use these inputs to determine internal weight values 112. In the same or other examples, weight estimator 110 can calibrate internal weight values 112 based on external weight values 212.

### Examples of Methods for Determining Weight Estimates

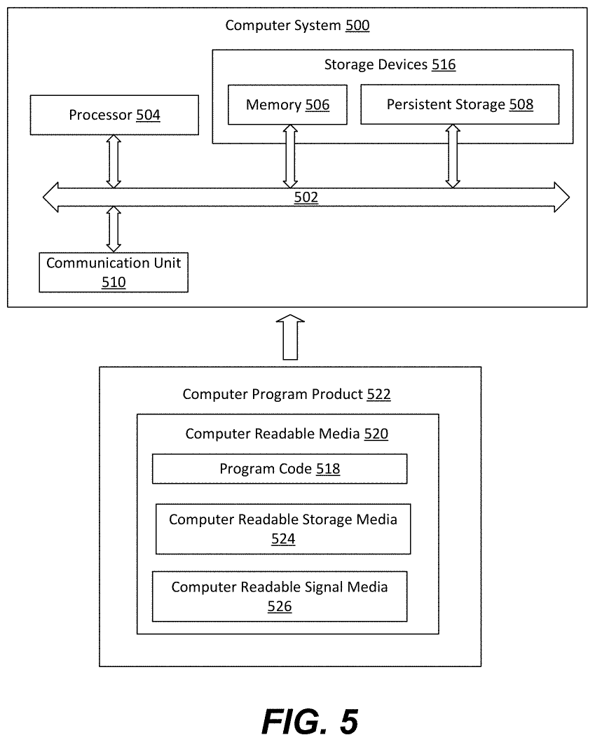

FIG. 3 is a process flowchart corresponding to method 300 of estimating the weight of commercial vehicle 100, in accordance with some examples. The key operations of this method are performed by weight estimator 110. Some examples and functions of weight estimator 110 are described above with reference to FIG. 3. Additional aspects of weight estimator 110 are presented with reference to FIG. 5.

Method 300 comprises receiving (block 310) input from one or more vehicle systems.

Various examples of these systems are described above with reference to FIG. 2A. These systems are communicatively coupled with weight estimator 110. Some examples of these inputs include, but are not limited to, load cell input 112, wheel travel input 122, vehicle speed 132, binary input 142 (e.g., trailer connected, bump-stop reached), tire pressure 152, and the like. These inputs are received, e.g., by weight estimator 110.

Method 300 proceeds with determining (block 320) one or more weight values 112 of vehicle 100. These weight values 112 are determined based on the received input. For example, weight estimator 110 may use various lookup tables, correlations, and other techniques (e.g., stored in the memory of weight estimator 110) to determine the weight estimate.

In some examples, weight values 112 comprise the total weight of vehicle 100 (e.g., suitable for controlling the overall power output), the weight per axle (e.g., to control braking bias, regenerative braking), the weight per wheel (e.g., for stability control), the weight at a specific location (e.g., to determine the load distribution on a vehicle), and/or center of mass in vehicle 100.

Method 300 proceed with checking (decision block 330) if multiple internal inputs have been received. In some examples, multiple different inputs are used to determine weight values 112. For example, speed values 132 may be analyzed together with power train data 136 and/or braking system inputs. In general, using multiple different inputs tends to increase the accuracy of weight values 112.

In some examples, different types of inputs are separately used to determine different sets of weight values 112. For example, wheel travel values 122 can be used to determine one set of weight values 112, and tire pressure values 152 can be used to determine another set of weight values 112. These determinations can be performed independently from each other, e.g., based on previously established correlations between these input types and vehicle weights. These sets can be then compared to determine (decision block 340) if these multiple sets of weight values 112 are within a set range. For example, the set of weight values 112 determined based on wheel travel values 122 can deviate from the set of weight values 112 determined based on tire pressure values 152. In these situations, one or more of these sets can be ignored (block 350) as less accurate. Alternatively, different sets can be combined (e.g., averaged) to determine a single set for additional use.

In some examples, method 300 comprises checking (decision block 360) if there are any external weight inputs. For example, vehicle 100 can be positioned on a scale, which provides external weight inputs to vehicle 100 or, more specifically, to weight estimator 110 as described above with reference to FIG. 2B. When available, the external weight inputs can be used for calibration weight estimator 110 (block 370), e.g., to modify various correlations between internal vehicle inputs and weight values 112, determined based on these inputs.

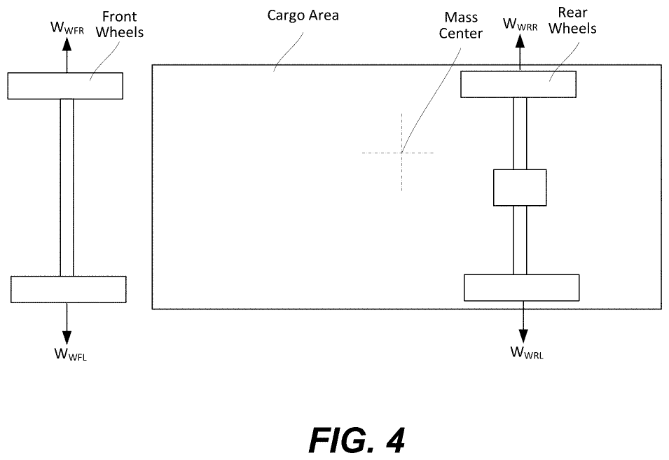

Method 300 proceeds with transmitting (block 380) weight values 112 to one or more vehicle systems, such as load analyzer 190 and/or maintenance scheduler 195. For example, load analyzed 190 can use weight values 112 to determine the distribution of the load on the vehicle (e.g., finding the mass center as schematically shown in FIG. 4). This information can be used, e.g., to change this distribution. This information can be used by loading personnel to change the load distribution. In some examples, load analyzed 190 can issue an overload alert. In some examples, weight values 112 are used by maintenance scheduler 195 together with other inputs (e.g., distance driver, fuel consumed) to determine maintenance schedule 196. Specifically, operating vehicle 100 with a higher load causes more wear on various systems, such as the vehicle's powertrain and brakes. Maintenance scheduler 195 can use a combination of the vehicle weight and distance traveled to identify what vehicle components need to be maintained and at what time. For example, the vehicle weight profile can be integrated over the distance traveled by vehicle 100 to determine the next maintenance point. In some examples, other inputs are used by maintenance scheduler 195, such as acceleration input 172 from IMU 170. For example, when vehicle 100 is operated in areas with heavy traffic(e.g., with frequent acceleration and braking), the wear on various vehicle systems can increase, in particular when vehicle 100 carries a heavy load.

### Computer System Examples

FIG. 5 is a block diagram of computer system 500, which can be operable as weight estimator 110 in vehicle 100 and is configured to estimate one or more weight values associated with vehicle 100. In some examples, one or more components of computer system 500 are implemented as onboard components of vehicle 100. In various examples, computer system 500 includes communications framework 502 (e.g., a bus), which provides communications between processor unit 504, memory 506, persistent storage 508, and communications unit 510. Communications unit 510 provides for communications with other vehicle systems or devices. In these illustrative examples, communications unit 510 may be a network interface card (e.g., a CAN-bus device), universal serial bus (USB) interface, or other suitable communications device/interface.

Processor unit 504 serves to execute instructions for software that may be loaded into memory 506. Processor unit 504 may be a number of processors, a multi-processor core, or some other type of processor, depending on the particular implementation.

Memory 506 and persistent storage 508 are examples of storage devices 516, e.g., computer-readable storage components. Memory 506 can be a random access memory (RAM) or any other suitable volatile or non-volatile storage device. Persistent storage 508 may take various forms, e.g., a hard drive, a flash memory, or some combination of the above. Instructions for the operating system, applications, and/or programs may be located in storage devices 516. The processes of the different examples may be performed by processor unit 504 using computer-implemented instructions, which may be located in a memory, such as memory 506.

These instructions are referred to as program code, computer usable program code, or computer-readable program code. The program code in the different examples may be embodied on different physical or computer-readable storage media, such as memory 506 or persistent storage 508. Program code 518 is located in a functional form on computer-readable media 520 that may be loaded onto or transferred to computer system 500 for execution by processor unit 504. Program code 518 and computer-readable media 520 form computer program product 522 in these illustrative examples. In one example, computer-readable media 520 may be computer-readable storage media 524 or computer-readable signal media 526.

In these illustrative examples, computer-readable storage media 524 is a physical or tangible storage device used to store program code 518 rather than a medium that propagates or transmits program code 518.

Alternatively, program code 518 may be transferred to computer system 500 using computer-readable signal media 526. Computer-readable signal media 526 may be, for example, a propagated data signal containing program code 518. For example, computer-readable signal media 526 may be an electromagnetic signal, an optical signal, and/or any other suitable type of signal. These signals may be transmitted over communications links, such as wireless communications links, optical fiber cable, coaxial cable, a wire, and/or any other suitable type of communications link.

### Conclusion

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

1. A method of estimating a total weight of a commercial vehicle, the method comprising:
obtaining multiple inputs, associated with the commercial vehicle, using a first set of systems of the commercial vehicle,
wherein the first set of systems comprises one or more of a wheel travel sensor, a bump-stop sensor, a speed sensor a tire pressure monitoring system, an inertial measurement unit, and a trailer presence sensor;
receiving, using a communication unit of a weight estimator of the commercial vehicle, the multiple inputs from the first set of systems of the commercial vehicle communicatively coupled to the communication unit,
wherein the first set of systems is communicatively coupled to the weight estimator,
wherein the multiple inputs are received from multiple different systems in the first set of systems of the commercial vehicle, and wherein the multiple inputs comprise at least one of one or more wheel travel values, one or more bump stop outputs, a speed value, power train data, a trailer presence, and one or more tire pressure values;
determining, using a processor of the weight estimator of the commercial vehicle, one or more weight values corresponding to the total weight of the commercial vehicle based on the multiple inputs received from the the first set of systems,
wherein determining the one or more weight values is performed using one or more correlation techniques of weight values and input values,
wherein the correlation techniques are stored as a program code in a memory of the weight estimator of the commercial vehicle and available to the processor such that the processor executes the program code for determining the one or more weight values based on the multiple inputs,
wherein each of the multiple inputs is separately used for determining different sets of weight values independently from each other, and
wherein determining the one or more weight values comprises
comparing the different sets of weight values to determine the one or
more of weight values that are within a set range and
transmitting, using the communication unit of the weight estimator of the commercial vehicle, the one or more weight values to a maintenance scheduler of the commercial vehicle communicatively coupled to the communication unit; and
using the maintenance scheduler determining a maintenance schedule for the commercial vehicle based on the one or more weight values, received from the weight estimator, and a driven distance.

2-4. (canceled)

5. The method of claim 1, wherein the multiple inputs further comprise one or more load cell outputs, received from load cell of the commercial vehicle.

6. The method of claim 1, wherein:
the multiple inputs comprise the one or more wheel travel values received from the wheel travel sensor, and
determining the one or more weight values comprises analyzing the one or more wheel travel values based on vehicle suspension settings.

7. The method of claim 1, wherein:
the multiple inputs comprise the one or more bump stop outputs received from the bump-stop sensor, and
determining the one or more weight values comprises analyzing the one or more bump stop outputs based on vehicle suspension settings.

8. The method of claim 7, wherein:
the multiple inputs comprise acceleration values, received from the inertial measurement unit, and
determining the one or more weight values is further performed based on the acceleration values.

9. The method of claim 1, wherein:
the multiple inputs comprise a speed value, received at different times, and
determining the one or more weight values comprises determining vehicle acceleration from changes in the speed value.

10. The method of claim 9, wherein determining the one or more weight values further comprises comparing the vehicle acceleration to the power train data.

11. The method of claim 1, wherein the one or more weight values comprise at-wheel weight values, each corresponding to each individual wheel of the commercial vehicle.

12. The method of claim 11, wherein:
the at-wheel weight values are determined from the tire pressure values, and
the tire pressure values are obtained for each individual wheel of the commercial vehicle.

13. The method of claim 12, wherein:
the multiple inputs comprise ambient temperature, and
the at-wheel weight values are determined are further determined based on the ambient temperature.

14. The method of claim 1, wherein:
the one or more weight values comprise the trailer presence received from the trailer presence sensor, and
the trailer presence sensor generates the trailer presence based on one or more of trailer lights and trailer brakes.

15. The method of claim 1, wherein:
the multiple inputs comprise a user input received from a user interface,
the user interface comprises one or more of a touch-screen in a vehicle cabin or a driver's mobile device, communicatively coupled to the weight estimator.

16. The method of claim 15, wherein the user input is selected from the group of an externally obtained vehicle weight and a trailer presence.

17. The method of claim 1, wherein the one or more weight values are selected from the group consisting of a total weight of the commercial vehicle, a weight per axle of the commercial vehicle, a weight per wheel of the commercial vehicle, and weight at a specific location in the commercial vehicle.

18. The method of claim 1, wherein the correlations of weight values and input values are arranged in one or more lookup tables.

19-20. (canceled)

21. The method of claim 1, wherein:
one of the multiple inputs is the speed value, and
another one of the multiple inputs is the power train data.

22. The method of claim 1, wherein:
one of the multiple inputs is the one or more wheel travel values, and
another one of the multiple inputs is the one or more tire pressure values.

23. The method of claim 1, wherein the at least one set of the different sets of weight values is ignored when the at least one set of the different sets of weight values is outside of a set range.
